(19) United States
(12) Patent Application Publication
(10) Pub. No.: US 2024/0142976 A1
(43) Pub. Date: May 2, 2024

(54) INFORMATION PROCESSING DEVICE

(71) Applicant: TOYOTA JIDOSHA KABUSHIKI KAISHA, Toyota-shi (JP)

(72) Inventor: Yuki WAKAYAMA, Toyota-shi (JP)

(73) Assignee: TOYOTA JIDOSHA KABUSHIKI KAISHA, Toyota-shi (JP)

(21) Appl. No.: 18/449,169

(22) Filed: Aug. 14, 2023

(30) Foreign Application Priority Data
Nov. 1, 2022 (JP) 2022-175537

(51) Int. Cl. G05D 1/00; G05D 1/02; H04B 17/318

(52) U.S. Cl. CPC G05D 1/0055; G05D 1/0022; G05D 1/0274; H04B 17/318

(57) ABSTRACT

An information processing device for controlling a mobile object, the information processing device comprising: a communication unit that performs communication with the mobile object; a function control unit that controls a function necessary for causing the mobile object to autonomously travel; and a switching control unit that switches whether to control at least a part of the necessary functions by the information processing device or by the mobile object based on a communication state between the information processing device and the mobile object.

### CROSS-REFERENCE TO RELATED APPLICATION

This application claims priority to Japanese Patent Application No. 2022-175537 filed on Nov. 1, 2022, incorporated herein by reference in its entirety.

### BACKGROUND

### 1. Technical Field

The present disclosure relates to an information processing device that controls a mobile object.

### 2. DESCRIPTION OF RELATED ART

Japanese Unexamined Patent Application Publication No. 2019-176262 (JP 2019-176262 A) discloses a mobile object that moves autonomously by efficiently utilizing radio resources, and an information processing device provided in the mobile object.

### SUMMARY

There is a possibility that, when the mobile object is controlled by an instruction via communication from the information processing device side provided on the cloud, the mobile object cannot be appropriately controlled depending on a communication state between the information processing device and the mobile object. For this reason, there is room for study on a method of controlling the mobile object by the information processing device via communication.

The present disclosure has been made in view of the above issue, and an object of the present disclosure is to provide an information processing device capable of suitably executing control of a mobile object based on a communication state with a mobile object or the like.

In order to solve the above issue, an aspect of the present disclosure is an information processing device that controls a mobile object that includes: a communication unit that communicates with the mobile object; a function control unit that controls a function required for causing the mobile object to be autonomously driven; and a switching control unit that switches at least part of the function required to be controlled by the information processing device or by the mobile object based on a communication state between the information processing device and the mobile object.

According to the information processing device of the present disclosure, it is possible to suitably execute the control of the mobile object based on the communication state between the information processing device and the mobile object.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a system including an information processing device and a mobile object according to an embodiment of the present disclosure;

FIG. 2 is a diagram illustrating an example of an image of a map held by an information processing device;

FIG. 3A is a flowchart of a first example of a mobile object control executed by an information processing device;

FIG. 3B is a flowchart of a first example of a mobile object control executed by an information processing device;

FIG. 4A is a flowchart of a second example of mobile object control executed by an information processing device;

FIG. 4B is a flowchart of a second example of mobile object control executed by an information processing device;

FIG. 4C is a flowchart illustrating a second example mobile object control executed by an information processing device.

### DETAILED DESCRIPTION OF EMBODIMENTS

In the information processing device of the present disclosure, when remote control of a mobile object is performed, information on the strength of wireless communication performed between the information processing device and the mobile object is created in advance in a map format of a travel area, and a control subject of a specific function implemented by the mobile object is switched between the information processing device and the mobile object based on the communication strength on the map corresponding to the current point of the mobile object. Thereby, the control of the mobile object is suitably performed.

Hereinafter, embodiments of the present disclosure will be described in detail with reference to the drawings.

### Embodiment

### Configuration

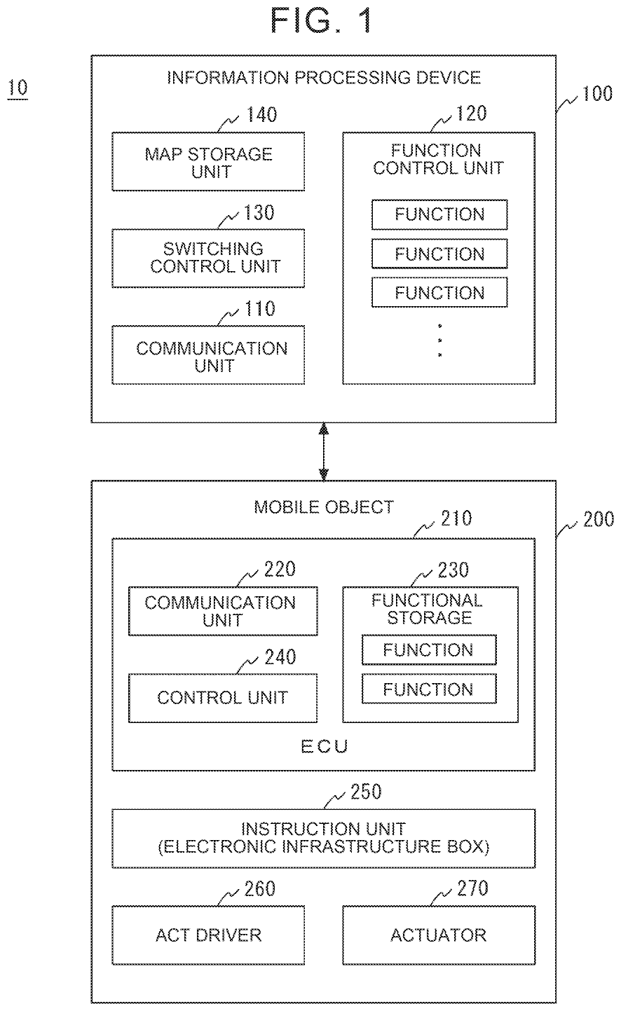

FIG. 1 is a schematic diagram illustrating an overall configuration example of a system 10 including an information processing device 100 according to an embodiment of the present disclosure and a mobile object 200 to be controlled by the information processing device 100.

### (1) Information Processing Device

The information processing device 100 is communicably connected to the mobile object 200, and is configured to be capable of performing predetermined control with respect to the mobile object 200 via communication. In the present embodiment, the information processing device 100 controls functions necessary for realizing autonomous traveling by the mobile object 200. The information processing device 100 is provided in, for example, a cloud server. The information processing device 100 includes a communication unit 110, a function control unit 120, a switching control unit 130, and a map storage unit 140.

The communication unit 110 is configured to execute predetermined communication with the mobile object 200 and transmit, to the mobile object 200, an instruction regarding control of a function necessary for causing the mobile object 200 to autonomously travel, an instruction regarding control transfer of a specific function to be described later, and the like. In addition, the communication unit 110 can receive information (described later) on the autonomous traveling state of the mobile object 200 from the mobile object 200 as needed.

The function control unit 120 has various functions necessary for causing the mobile object 200 to autonomously travel, and is configured to control these functions. More specifically, the function control unit 120 implements an application (APP) of a function required for causing the mobile object 200 to autonomously travel, and realizes a predetermined function by executing the application. At least some of the functions of the function control unit 120 (hereinafter, referred to as “specific functions”) are also implemented in the mobile object 200.

The switching control unit 130 performs control for switching between whether to execute control of a specific function by the function control unit 120 of the information processing device 100 or by the mobile object 200 based on the communication status between the information processing device 100 and the mobile object 200. In addition, the switching control unit 130 detects a failure condition of an ECU 210 to be described later mounted on the mobile object 200, and performs control for switching a subject that executes control of a particular function. These switching instructions are transmitted to the mobile object 200 via the communication unit 110.

The map storage unit 140 stores, for example, a map indicating information on the communication strength at each position of the movable area with respect to a range (hereinafter referred to as a “movable area”) in which the mobile object 200 can move. This map is created in advance on the basis of a simulation, an actual measurement value, or the like in the movable area.

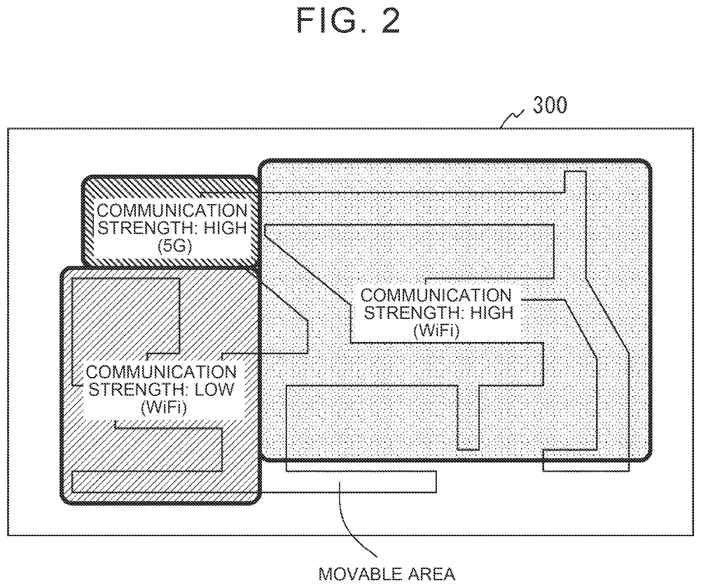

FIG. 2 illustrates an image diagram of the map 300 stored in the map storage unit 140. In FIG. 2, the map 300 includes an area having a high communication strength using 5G communication, an area having a high communication strength using WiFi communication, and an area having a low communication strength using WiFi communication. Note that the information set in the map 300 may be a numerical value of the communication strength or the like in addition to the high-low classification (level) of the communication strength.

All or a part of the configuration included in the information processing device 100 includes a processor such as a Central Processing Unit (CPU, a memory such as a Random Access Memory (RAM, a readable/writable storage medium such as a hard disk drive (HDD) or a solid state drive (SSD), an input/output interface, and the like, and realizes all or a part of the above-described configuration by the processor reading and executing a program stored in the memory.

### (2) Mobile Object

The mobile object 200 is configured to be able to communicate with the information processing device 100, and is a mobility capable of performing autonomous traveling in accordance with control from the information processing device 100 and its own control. Although FIG. 1 illustrates an example in which one mobile object 200 is connected to the information processing device 100, a plurality of mobile objects 200 may be connected to the information processing device 100. The mobile object 200 includes components of an ECU 210, an instruction unit 250, an ACT driving unit 260, and an actuator 270.

ECU 210 is an Electronic Control Unit that controls the entire autonomous travel of the mobile object 200, and includes a communication unit 220, a function storage unit 230, and a control unit 240.

The communication unit 220 is a configuration for performing communication with the information processing device 100 and receiving a control instruction related to a function for the mobile object 200 to perform autonomous travel. In addition, the communication unit 220 provides information on the autonomous traveling state acquired by the mobile object 200 to the information processing device 100. The information regarding the autonomous traveling state includes a current point of the mobile object 200, an operating state (traveling/stopping), a moving speed, a moving direction, a surrounding detection object, and the like. Further, the communication unit 220 can receive an instruction to transfer the control of the specific function from the information processing device 100 to the mobile object 200 (control transfer) or an instruction to return the control of the specific function transferred to the mobile object 200 to the information processing device 100 (control transfer end).

The function storage unit 230 is a configuration for storing a specific function necessary for causing the mobile object 200 to autonomously travel. In other words, certain functions are implemented in ECU 210. Specific functions stored in the function storage unit 230 include, for example, a function (one-dimensional information determination function) for determining only one-dimensional information acquired from a radar or the like, an emergency stop function based on the determination, and the like, which are functions for securing safety in a simple process in an emergency among all functions related to autonomous traveling of the mobile object 200. All functions necessary for autonomous traveling of the mobile object 200 including this specific function are implemented in the function control unit 120 of the information processing device 100. Therefore, the information processing device 100 and the mobile object 200 are provided for a specific function in an overlapping manner.

The control unit 240 is a configuration for performing control necessary for realizing autonomous traveling by the mobile object 200. The control unit 240 controls the instruction unit 250 to operate the actuator 270 with respect to ACT driving unit 260 that controls the actuator 270 corresponding to the function, based on the control instruction of the function received from the information processing device 100. Further, the control unit 240 executes control of a specific function stored in the function storage unit 230 or transfers control of a specific function stored in the function storage unit 230 to the instruction unit 250 in response to an instruction (control transfer/control transfer end) received from the information processing device 100 based on a communication status between the information processing device 100 and the mobile object 200. Furthermore, the control unit 240 detects a failure state of the functional unit related to its own processing/memory, and notifies the information processing device 100 of the detected failure state.

The instruction unit 250 is configured to give a predetermined instruction to ACT driving unit 260 in order to cause the mobile object 200 to autonomously travel under the control of the control unit 240. When there is a plurality of ACT driving units 260, the instruction unit 250 distributes appropriate instructions to the plurality of ACT driving units 260. Therefore, the instruction unit 250 may be referred to as an electronic infrastructure box. The instruction unit 250 can be configured by, for example, a low-performance ECU capable of executing only a function having a lower process load than that of ECU 210.

ACT driving unit 260 is configured to operate the actuator 270 based on an instruction from the instruction unit 250. ACT driver 260 is, for example, an actuator ECU or a driver unit (EDU). A plurality of ACT driving units 260 may be provided in accordance with the numbers of the actuators 270.

The actuator 270 is a device for executing a movement such as running, stopping, or bending of the mobile object 200, and is, for example, a traveling motor or a sensor. A plurality of actuators 270 may be provided.

All or a part of the configuration included in the mobile object 200 typically includes a processor such as a CPU, a memory such as a RAM, a readable/writable storage medium such as a HDD and a SSD, an input/output interface, and the like, and realizes all or a part of the above-described configuration by the processor reading and executing a program stored in the memory.

### Control

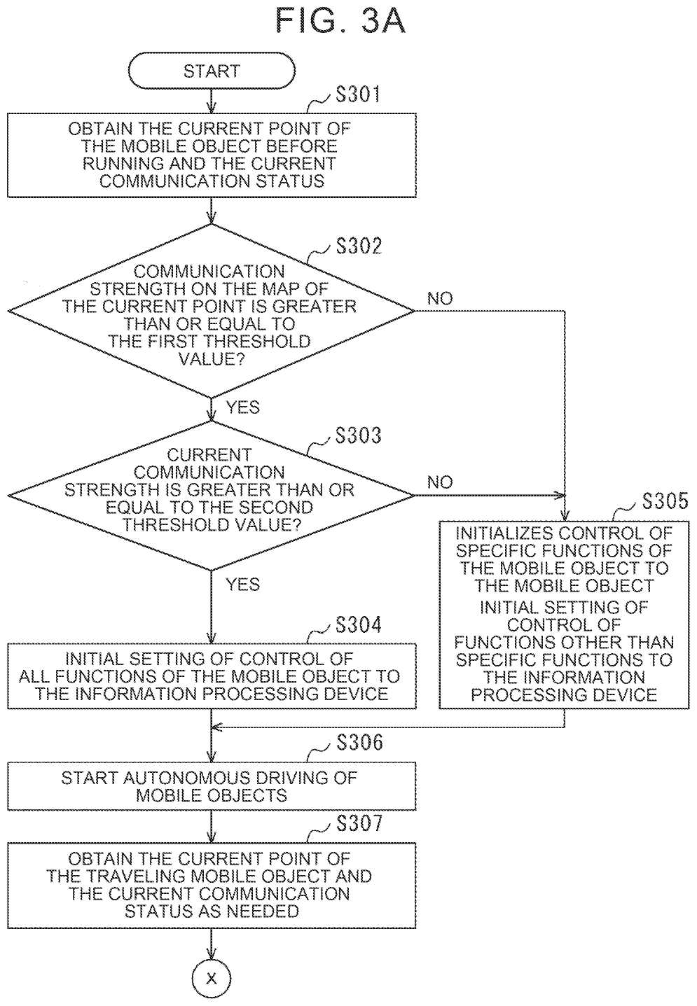

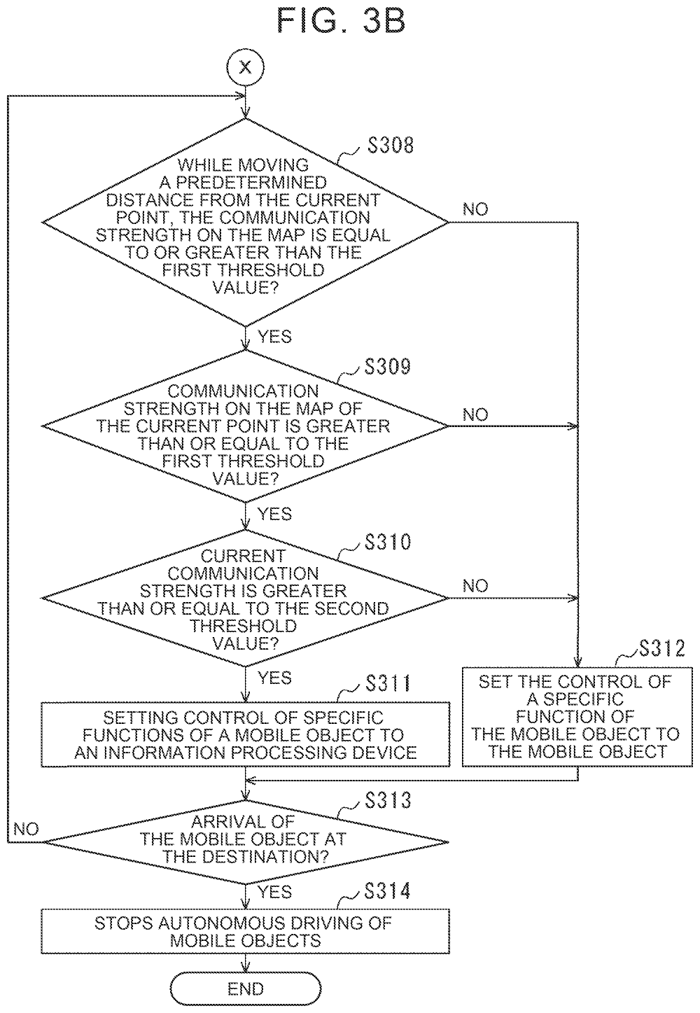

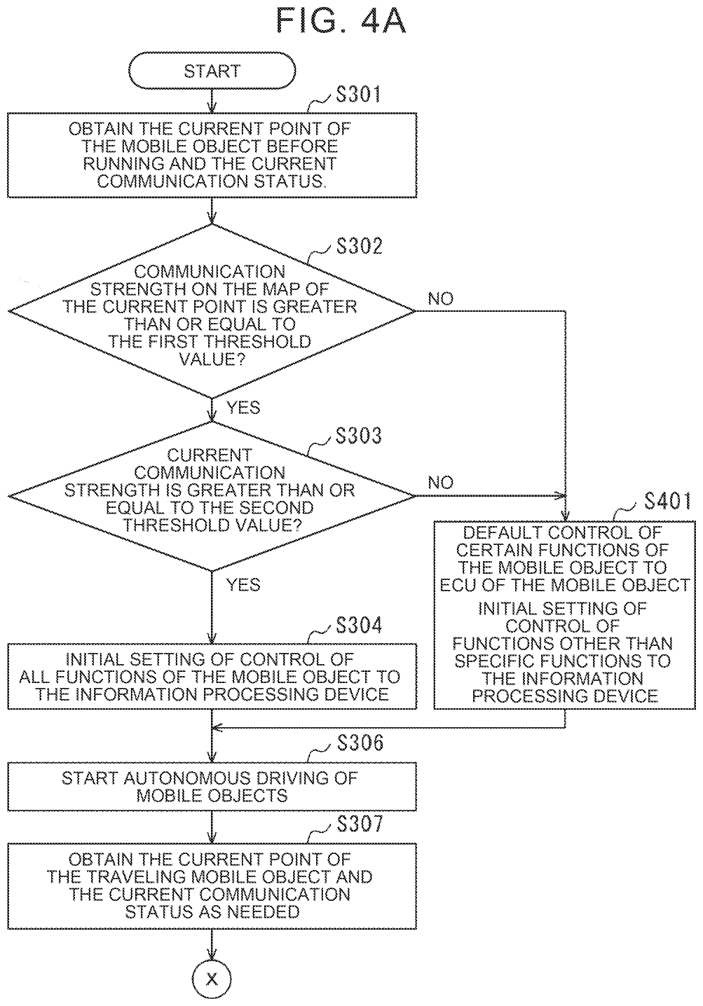

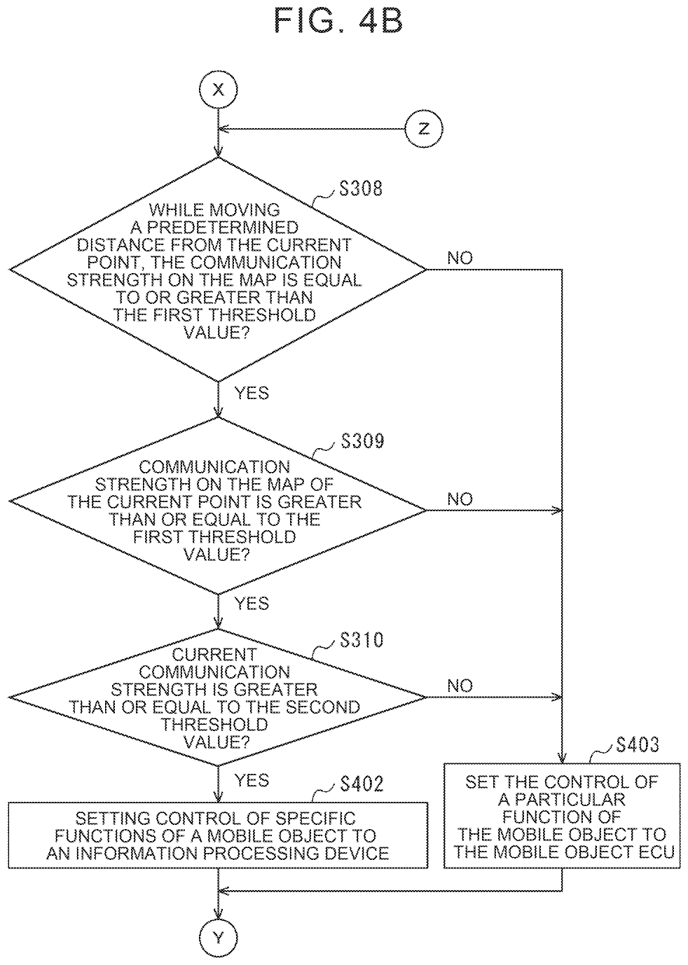

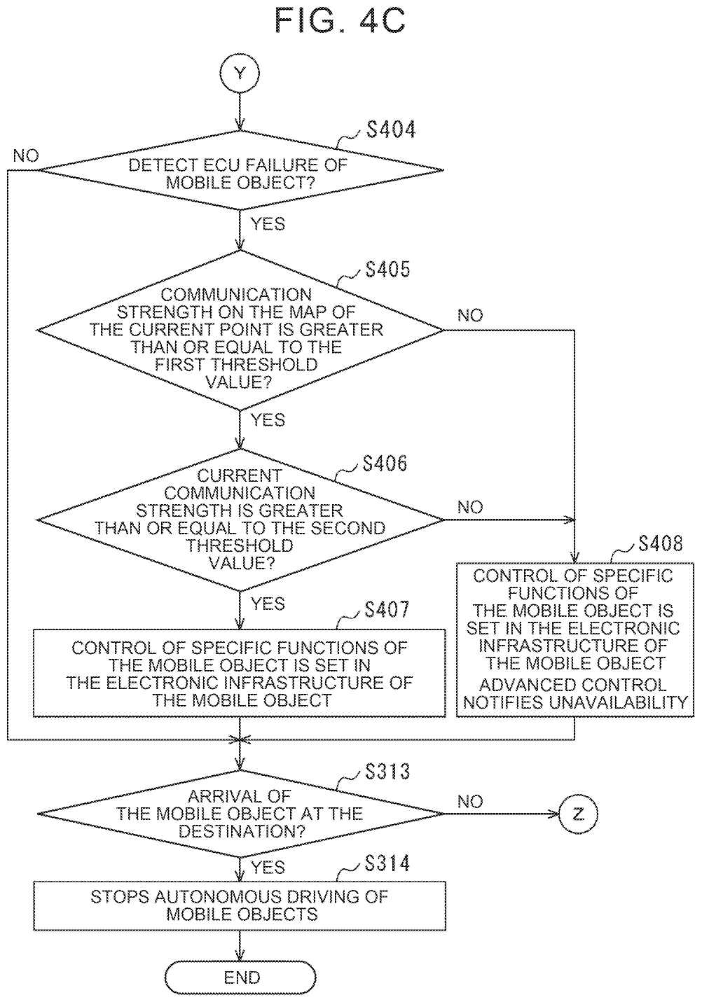

Referring now further to FIG. 3A, FIG. 3B, FIG. 4A, FIG. 4B, and FIG. 4C, the controls performed in the system 10 according to the present embodiment will now be described.

### (1) First Example of Mobile Object Control

FIGS. 3A and 3B are diagrams illustrating a process of a first embodiment of mobile object control executed by an information processing device 100. The process of FIG. 3A and the process of FIG. 3B are connected by a coupler X. The mobile object control of the first example is started, for example, when a destination traveling with respect to the mobile object 200 is set.

### S301

The information processing device 100 acquires the current point (information on the autonomous traveling state) of the mobile object 200 before traveling from the mobile object 200, and also acquires the current communication status between the information processing device 100 and the mobile object 200. The communication status includes the actual communication strength between the information processing device 100 and the mobile object 200. When the information processing device 100 acquires the current point of the mobile object 200 and the current communication status, the process proceeds to S302.

### S302

The information processing device 100 refers to the map 300 stored in the map storage unit 140, and determines whether or not the communication strength set at the position on the map 300 corresponding to the current point of the mobile object 200 before traveling is equal to or greater than the first threshold value. This determination is made in order to determine whether the current point of the mobile object 200 is at a position where the information processing device 100 and the mobile object 200 are estimated to be capable of high-quality communication. Therefore, the first threshold value can be set to an appropriate value that can be determined to be capable of high-quality communication according to the communication strength set in the map 300. When the information processing device 100 determines that the communication strength on the map 300 of the current point is equal to or greater than the first threshold value (S302, Yes), the process proceeds to S303. On the other hand, if the information processing device 100 determines that the communication strength on the map 300 of the current point is less than the first threshold value (S302, No), the process proceeds to S305.

### S303

The information processing device 100 determines whether or not the current communication strength between the information processing device 100 and the mobile object 200 is equal to or greater than a second threshold value. This determination is made in order to determine whether the actual communication strength at the current point is high enough that the information processing device 100 and the mobile object 200 can perform high-quality communication. Therefore, the second threshold value can be set to, for example, a value that is less likely to cause a communication delay or a communication interruption. When the information processing device 100 determines that the present communication strength is equal to or greater than the second threshold value (S303, Yes), the process proceeds to S304. On the other hand, if the information processing device 100 determines that the communication strength at the current point is less than the second threshold value (S303, No), the process proceeds to S305.

### S304

The information processing device 100 performs initial setting so that the information processing device 100 performs control of all functions necessary for causing the mobile object 200 to autonomously travel. That is, the information processing device 100 controls all functions necessary for the function control unit 120 to cause the mobile object 200 to autonomously travel based on the information on the autonomous travel state acquired from the mobile object 200. By transmitting an instruction based on this control to the mobile object 200, the information processing device 100 switches to a setting in which the mobile object 200 performs autonomous traveling. When the information processing device 100 initializes the information processing device 100 to control all the functions of the mobile object 200, the process proceeds to S306.

### S305.

The information processing device 100 performs initial setting so as to execute control of a specific function on the mobile object 200 side among all functions necessary for causing the mobile object 200 to autonomously travel, and performs initial setting so as to execute control of a function other than the specific function on the information processing device 100 side. That is, the information processing device 100 causes the mobile object 200 to internally control the specific function based on the information on the autonomous traveling state acquired by the mobile object 200 itself. The information processing device 100 externally controls functions other than the specific functions by the information processing device 100 based on the information on the autonomous traveling state acquired from the mobile object 200. By transmitting an instruction based on the external control to the mobile object 200, the information processing device 100 switches to a setting in which the mobile object 200 performs autonomous traveling. In this case, among the functions other than the specific function, the function control unit 120 may be set (controlled stop) so as not to control a high-performance function having a large load such as obstacle avoidance processing using two-dimensional and three-dimensional information and data analysis, for example. When the information processing device 100 initializes the control of a specific function to be executed by the mobile object 200 and initializes the control of a function other than the specific function to be executed by the information processing device 100, the process proceeds to S306.

### S306

The information processing device 100 starts autonomous traveling of the mobile object 200 based on the control content that is initially set. When the autonomous traveling of the mobile object 200 is started by the information processing device 100, the process proceeds to S307.

### S307

The information processing device 100 acquires the current point of the mobile object 200 while traveling and the current communication status between the information processing device 100 and the mobile object 200 as needed. The timing at which these pieces of information are acquired is not particularly limited, but may be, for example, when a predetermined time has elapsed, when the mobile object 200 travels a predetermined distance, or when a communication situation has changed. When the information processing device 100 acquires the current point of the mobile object 200 and the current communication status, the process proceeds to S308.

### S308

The information processing device 100 refers to the map 300 stored in the map storage unit 140, and determines whether or not the communication strength set on the map 300 is always equal to or greater than the first threshold value while the mobile object 200 moves a predetermined distance from the current point to the destination. This determination is made in order to determine whether or not there is a possibility that the communication quality between the information processing device 100 and the mobile object 200 may deteriorate during a period in which the mobile object 200 moves by a predetermined distance. The first threshold value used in this determination is the same as the threshold used in the determination of S302, but a different threshold may be used. If the information processing device 100 determines that the communication strength on the map 300 while moving a predetermined distance from the current point is not less than the first threshold value (S308, Yes), the process proceeds to S309. On the other hand, if the information processing device 100 determines that the communication strength on the map 300 is less than the first threshold value at any position while moving a predetermined distance from the current point (S308, No), the process proceeds to S312.

### S309

The information processing device 100 refers to the map 300 stored in the map storage unit 140, and determines whether or not the communication strength set at the position on the map 300 corresponding to the current point of the traveling mobile object 200 is equal to or greater than the first threshold value. The reason for this determination is the same as in the above S302. When the information processing device 100 determines that the communication strength on the map 300 of the current point is equal to or greater than the first threshold value (S309, Yes), the process proceeds to S310. On the other hand, if the information processing device 100 determines that the communication strength on the map 300 of the current point is less than the first threshold value (S309, No), the process proceeds to S312.

### S310

The information processing device 100 determines whether or not the current communication strength between the traveling mobile object 200 and the information processing device 100 is equal to or greater than a second threshold value. The reason for this determination is the same as in the above S303. When the information processing device 100 determines that the present communication strength is equal to or greater than the second threshold value (S310, Yes), the process proceeds to S311. On the other hand, if the information processing device 100 determines that the communication strength at the current point is less than the second threshold value (S310, No), the process proceeds to S312.

### S311

The information processing device 100 sets the information processing device 100 to execute control of a specific function necessary for causing the mobile object 200 to autonomously travel. That is, in a case where the control of the specific function has been transferred to the mobile object 200, the information processing device 100 switches the control of the specific function to the setting for returning to the information processing device 100. In this case, if there is a high function such as an avoidance measure or a data analysis that has stopped the control, for example, the control is resumed. When the information processing device 100 sets the information processing device 100 to control a particular function of the mobile object 200, the process proceeds to S313.

### S312

The information processing device 100 sets the control of a specific function necessary for causing the mobile object 200 to autonomously travel to be executed on the mobile object 200 side. That is, when the information processing device 100 controls the specific function, the information processing device 100 switches the setting to transfer the control of the specific function to the mobile object 200. When the information processing device 100 sets the mobile object 200 to control a particular function of the mobile object 200, the process proceeds to S313.

### S313

The information processing device 100 determines whether or not the mobile object 200 has arrived at the destination. This determination can be made by information regarding the autonomous driving state received from the mobile object 200. When the information processing device 100 determines that the mobile object 200 has arrived at the destination (S313, Yes), the process proceeds to S314. On the other hand, if the information processing device 100 determines that the mobile object 200 has not yet arrived at the destination (S313, No), the process proceeds to S308.

### S314

The information processing device 100 stops the autonomous travel of the mobile object 200. When the autonomous traveling of the mobile object 200 is stopped by the information processing device 100, the present mobile object control is ended.

### (2) Second Example of Mobile Object Control

FIGS. 4A, 4B, and 4C are flow charts for describing the process of the second embodiment of the mobile object control executed by the information processing device 100. The process of FIG. 4A, the process of FIG. 4B, and the process of FIG. 4C are connected by the couplers X, Y, and Z. From S301 to S304 and S306 to S307 shown in FIG. 4A, S308 to S310 shown in FIG. 4B, and S313 and S314 shown in FIG. 4C are the same as the above-described process sequence of the first embodiment of the mobile object control. Hereinafter, a second example of the mobile object control will be described with a focus on processing different from the first example of the mobile object control. The mobile object control of the second example is started, for example, when a destination traveling with respect to the mobile object 200 is set.

### S302

The information processing device 100 refers to the map 300 stored in the map storage unit 140, and determines whether or not the communication strength set at the position on the map 300 corresponding to the current point of the mobile object 200 before traveling is equal to or greater than the first threshold value. When the information processing device 100 determines that the communication strength on the map 300 of the current point is equal to or greater than the first threshold value (S302, Yes), the process proceeds to S303. On the other hand, if the information processing device 100 determines that the communication strength on the map 300 of the current point is less than the first threshold value (S302, No), the process proceeds to S401.

### S303

The information processing device 100 determines whether or not the current communication strength between the information processing device 100 and the mobile object 200 is equal to or greater than a second threshold value. When the information processing device 100 determines that the present communication strength is equal to or greater than the second threshold value (S303, Yes), the process proceeds to S304. On the other hand, if the information processing device 100 determines that the communication strength at the current point is less than the second threshold value (S303, No), the process proceeds to S401.

### S401

The information processing device 100 performs initial setting so as to execute control of a specific function on the mobile object 200 side among all functions necessary for causing the mobile object 200 to autonomously travel, and performs initial setting so as to execute control of a function other than the specific function on the information processing device 100 side. That is, the information processing device 100 internally controls a particular function in ECU 210 of the mobile object 200 based on the autonomous driving condition information acquired by the mobile object 200 itself. The information processing device 100 is externally controlled by the function control unit 120 of the information processing device 100 on the basis of the information on the autonomous traveling state acquired from the mobile object 200 with respect to functions other than the specific functions. By transmitting an instruction based on the external control to the mobile object 200, the information processing device 100 switches to a setting in which the mobile object 200 performs autonomous traveling. In this case, the function control unit 120 may set (control stop) the advanced functions such as avoidance treatment and data analysis among the functions other than the specific function so as not to be controlled. When the information processing device 100 initializes the control of a specific function to be executed by the mobile object 200 and initializes the control of a function other than the specific function to be executed by the information processing device 100, the process proceeds to S306.

### S308

The information processing device 100 refers to the map 300 stored in the map storage unit 140, and determines whether or not the communication strength set on the map 300 is always equal to or greater than the first threshold value while the mobile object 200 moves a predetermined distance from the current point to the destination. If the information processing device 100 determines that the communication strength on the map 300 while moving a predetermined distance from the current point is not less than the first threshold value (S308, Yes), the process proceeds to S309. On the other hand, if the information processing device 100 determines that the communication strength on the map 300 is less than the first threshold value at any position while moving a predetermined distance from the current point (S308, No), the process proceeds to S403.

The information processing device 100 refers to the map 300 stored in the map storage unit 140, and determines whether or not the communication strength set at the position on the map 300 corresponding to the current point of the traveling mobile object 200 is equal to or greater than the first threshold value. When the information processing device 100 determines that the communication strength on the map 300 of the current point is equal to or greater than the first threshold value (S309, Yes), the process proceeds to S310. On the other hand, if the information processing device 100 determines that the communication strength on the map 300 of the current point is less than the first threshold value (S309, No), the process proceeds to S403.

### S310

The information processing device 100 determines whether or not the current communication strength between the traveling mobile object 200 and the information processing device 100 is equal to or greater than a second threshold value. When the information processing device 100 determines that the present communication strength is equal to or greater than the second threshold value (S310, Yes), the process proceeds to S402. On the other hand, if the information processing device 100 determines that the communication strength at the current point is less than the second threshold value (S310, No), the process proceeds to S403.

### S402

The information processing device 100 sets the information processing device 100 to execute control of a specific function necessary for causing the mobile object 200 to autonomously travel. That is, when the control of the specific function is transferred to ECU 210 of the mobile object 200 in the above-described S305, or when the control of the specific function is transferred to the instruction unit 250 (electronic infrastructure) of the mobile object 200 in a S407 to be described later, the information processing device 100 switches the control of the specific function to the setting for returning to the information processing device 100. In this case, if there is a high function such as an avoidance measure or a data analysis that has stopped the control, for example, the control is resumed. When the information processing device 100 sets the information processing device 100 to control a particular function of the mobile object 200, the process proceeds to S404.

### S403

The information processing device 100 sets the control of a specific function necessary for causing the mobile object 200 to autonomously travel to be executed on the mobile object 200 side. That is, when the information processing device 100 controls the specific function, the information processing device 100 switches the setting to transfer the control of the specific function to ECU 210 of the mobile object 200. When the control of the particular function of the mobile object 200 is set to ECU 210 of the mobile object 200 by the information processing device 100, the process proceeds to S404.

### S404

The information processing device 100 determines whether or not a predetermined failure has been detected in ECU 210 of the mobile object 200. The predetermined failure is a failure of the processing/memory unit of the control unit 240. Whether or not a failure has occurred can be determined based on information about an autonomous traveling state acquired from the mobile object 200. When the information processing device 100 detects a failure of ECU 210 of the mobile object 200 (S404, Yes), the process proceeds to S405. On the other hand, when the information processing device 100 does not detect the failure of ECU 210 of the mobile object 200 (S404, No), the process proceeds to S313.

### S405

The information processing device 100 refers to the map 300 stored in the map storage unit 140, and determines whether or not the communication strength set at the position on the map 300 corresponding to the current point of the traveling mobile object 200 is equal to or greater than the first threshold value. This determination is the same as the determination in the above S309. When the information processing device 100 determines that the communication strength on the map 300 of the current point is equal to or greater than the first threshold value (S405, Yes), the process proceeds to S406. On the other hand, if the information processing device 100 determines that the communication strength on the map 300 of the current point is less than the first threshold value (S405, No), the process proceeds to S408.

### S406

The information processing device 100 determines whether or not the current communication strength between the traveling mobile object 200 and the information processing device 100 is equal to or greater than a second threshold value. This determination is the same as the determination in the above S310. When the information processing device 100 determines that the present communication strength is equal to or greater than the second threshold value (S406, Yes), the process proceeds to S407. On the other hand, if the information processing device 100 determines that the communication strength at the current point is less than the second threshold value (S406, No), the process proceeds to S408.

### S407

The information processing device 100 sets the instruction unit 250 (electronic infrastructure) of the mobile object 200 to control a specific function necessary for causing the mobile object 200 to autonomously travel. That is, when the information processing device 100 controls a specific function in S304 or S402 in the information processing device 100 or when the control of the specific function is transferred to ECU 210 of the mobile object 200 in S305, the information processing device switches to a setting for transferring the control of the specific function to the instruction unit 250 (electronic infrastructure) of the mobile object 200 that can be controlled as long as the specific function has a small processing load. In this case, the information processing device 100 can continuously control the highly functional control such as the avoidance treatment and the data analysis. When the information processing device 100 sets the instruction unit 250 (electronic infrastructure) of the mobile object 200 to control a particular function of the mobile object 200, the process proceeds to S313.

### S408

The information processing device 100 sets the instruction unit 250 (electronic infrastructure) of the mobile object 200 to control a specific function necessary for causing the mobile object 200 to autonomously travel. That is, when the information processing device 100 controls a specific function in S304 or S402 in the information processing device 100 or when the control of the specific function is transferred to ECU 210 of the mobile object 200 in S305, the information processing device switches to a setting for transferring the control of the specific function to the instruction unit 250 (electronic infrastructure) of the mobile object 200 that can be controlled as long as the specific function has a small processing load. In this case, the information processing device 100 makes it impossible to control the high-function control such as the avoidance treatment and the data analysis, and instructs the mobile object 200 to perform the display of the high-function unavailability or the like. When the information processing device 100 sets the instruction unit 250 (electronic infrastructure) of the mobile object 200 to control a particular function of the mobile object 200 and displays an unusable indication of a high function, the process proceeds to S313.

### Effects, etc.

As described above, according to the information processing device 100 for controlling the mobile object 200 according to an embodiment of the present disclosure, when it can be determined that there is a risk of communication delay or communication interruption based on the communication status between the map 300 relating to the communication quality created in advance based on the radio wave status and the information processing device 100 and the mobile object 200, the control of a specific function that can safely stop the mobile object 200 before at least a danger occurs among the functions necessary for autonomously traveling the mobile object 200 is transferred from the information processing device 100 side to the mobile object 200 side.

By this control, even when the mobile object 200 travels in an area where the communication quality is low, it is possible to stop only by the determination of the mobile object 200 itself in an emergency. Therefore, the control of the mobile object 200 can be suitably executed based on the communication status between the information processing device 100 and the mobile object 200.

In addition, even when a part of ECU 210 (processing/memory unit) of the mobile object 200 to which the control of the specific function has been transferred fails, the control of the specific function is transferred from ECU 210 to the lower-level electronic infrastructure box (instruction unit 250). Thus, when a failure occurs, the traveling of the mobile object 200 can be temporarily continued until the failure is dealt with by the administrator of the system 10 or the like.

Although an embodiment of the present disclosure has been described above, the present disclosure can be regarded as a system including not only an information processing device but also an information processing device and a mobile object, a method executed by a system including a processor and a memory, a program for executing the method, a computer-readable non-transitory storage medium storing a program, and the like.

The information processing device of the present disclosure is useful, for example, in a case where a mobile object is remotely controlled from an information processing device provided on a cloud side.

What is claimed is:

1. An information processing device that controls a mobile object, the information processing device comprising:
a communication unit that communicates with the mobile object;
a function control unit that controls a function required for causing the mobile object to be autonomously driven; and
a switching control unit that switches at least part of the function required to be controlled by the information processing device or by the mobile object based on a communication state between the information processing device and the mobile object.

2. The information processing device according to claim 1, wherein the switching control unit:
acquires a failure state of an electronic control unit mounted on the mobile object from the mobile object; and
switches the at least part of the function to be controlled by the information processing device or by an electronic infrastructure box provided in the mobile object based on the failure state of the electronic control unit.

3. The information processing device according to claim 1, further comprising a storage unit that stores a map indicating information on a communication strength at each position in an area in which the mobile object is movable, wherein the switching control unit switches the at least part of the function to be controlled by the mobile object when a current point of the mobile object is located at a position at which the communication strength on the map is less than a first threshold value.

4. The information processing device according to claim 3, wherein the switching control unit switches the at least part of the function to be controlled by the mobile object when the communication strength of communication with the mobile object is less than a second threshold value.

5. The information processing device according to claim 3, wherein the switching control unit switches the at least part of the function to be controlled by the mobile object at the current point when a position at which the communication strength on the map is less than the first threshold value is present in a route in which the mobile object moves from the current point by a predetermined distance.

6. The information processing device according to claim 4, wherein the switching control unit switches the at least part of the function that has been switched to be controlled by the mobile object to be controlled by the information processing device when the current point of the mobile object is located at a position at which the communication strength on the map is equal to or greater than the first threshold value and the communication strength of the communication with the mobile object is equal to or greater than the second threshold value.

7. The information processing device according to claim 1, wherein the at least part of function includes at least a one-dimensional information determination function and an emergency stop function.
